(19) United States
(12) Patent Application Publication
(10) Pub. No.: US 2017/0008470 A1
(43) Pub. Date: Jan. 12, 2017

(54) BACKUP BATTERY SYSTEM

(71) Applicant: YAZAKI CORPORATION, Tokyo (JP)

(72) Inventor: Hideaki Kikuchi, Shizuoka (JP)

(21) Appl. No.: 15/202,267

(22) Filed: Jul. 5, 2016

(30) Foreign Application Priority Data
Jul. 10, 2015 (JP) 2015-138271

(51) Int. Cl. B60R 16/033

(52) U.S. Cl. CPC B60R 16/033

(57) ABSTRACT

Provided is a backup battery system in which a backup required device and a backup battery capable of outputting backup electric power are connected with a backup electric wire. The backup battery is disposed one by one in sections obtained by dividing a vehicle into five sections, and the resultant five backup batteries, which are respectively disposed in the five sections, are connected to backup required devices in a number greater than the number of the sections. Each of the backup batteries in each of the sections is connected to the backup required device in the same section among the sections in a manner capable of supplying the backup electric power thereto.

### CROSS-REFERENCE TO RELATED APPLICATION(S)

The present application claims priority to and incorporates by reference the entire contents of Japanese Patent Application No. 2015-138271 filed in Japan on Jul. 10, 2015.

### BACKGROUND OF THE INVENTION

1. Field of the Invention

The present invention relates to a backup battery system.

2. Description of the Related Art

In devices which receive power supply from a vehicle battery, a serious problem may occur when the power supply is shut off and thus the device does not operate. A backup battery, which is different from the vehicle battery, is connected to the devices for normal operation even when the power supply from the vehicle battery is shut off (for example, refer to Japanese Patent Application Laid-open No. 2014-180941).

The inventors of the present application have made an examination with respect to a configuration in which a backup battery is connected to an important device similar to the invention described in Japanese Patent Application Laid-open No. 2014-180941, and have made an examination with respect to a configuration of allowing the device to operate even when power supply from a vehicle battery is shut off. Hereinafter, such device is referred to as a backup required device.

However, recently, along with higher performance in regard to an in-vehicle device, there is a tendency in which the number of backup required devices in a vehicle increases. Therefore, it is necessary to connect a backup battery to each of the backup required devices, and thus it is necessary to mount a lot of backup batteries in a vehicle.

With regard to the necessity, a configuration, in which one backup battery is installed in a vehicle, and the one backup battery and each of the plurality of backup required devices are connected, may be considered. However, in this case, for example, the connection is made by routing an electric wire from the one backup battery to each of the backup required devices present over a range from a front side to a rear side of the vehicle, and thus the electric wire, which is used in the vehicle, is lengthened excessively.

### SUMMARY OF THE INVENTION

The present invention has been made to solve the above-described problem, and an object thereof is to provide a backup battery system that is capable of further shortening an electric wire that connects a backup battery and a backup required device while suppressing an increase in the number of backup batteries which are mounted in a vehicle.

In order to achieve the above mentioned object, a backup battery system according to one aspect of the present invention includes a backup battery configured to output backup electric power and to be connected to a backup required device among devices receiving electric power supply from a vehicle battery, the backup required device being a device to which the backup electric power is capable of being supplied, wherein the backup battery is disposed in each of sections obtained by dividing a vehicle into a plurality of sections, a plurality of the backup batteries, which are respectively disposed in the plurality of sections, are connected to a plurality of the backup required devices in a number greater than the number of the sections, and the backup battery provided in each section is connected to the backup required device in the same section in a manner capable of supplying the backup electric power thereto.

According to the backup battery system according to the present invention, the plurality of backup batteries, which are respectively disposed in the plurality of sections, are connected to backup required devices in a number of greater than the number of the sections. Accordingly, the number of the backup batteries becomes smaller than the number of the backup required devices, and thus it is possible to suppress an increase in the number of the backup batteries which are mounted in the vehicle. In addition, the backup battery in each of the sections is connected to the backup required device in the same section in a manner capable of supplying backup electric power thereto. Accordingly, the backup battery is connected to only a backup required device in the section, and electric wire connection is not made to a backup required device which is in a different section and is spaced away from the backup battery. According to this, it is possible to further shorten an electric wire that connects the backup battery and the backup required device while suppressing an increase in the number of the backup batteries which are mounted in the vehicle.

According to another aspect of the present invention, in the backup battery system, it is preferable that the plurality of sections include four sections each of which is set to include the vicinity of each tire of the vehicle, and the backup batteries in the four sections are disposed to be close to the respective tires.

According to the backup battery system, the plurality of sections include four sections each of which is set to include the vicinity of each tire of the vehicle, and the backup batteries in the four sections are disposed to be close to the respective tire. Here, the backup required device mainly relates to vehicle traveling, and is mainly provided in the vicinity of the tire due to the relation to the vehicle traveling. Accordingly, when the backup battery is disposed to be close to the tire, it is possible to further shorten the electric wire that connects the backup battery and the backup required device.

According to still another aspect of the present invention, it is preferable that the backup battery system further includes a power supply control box provided one by one in the plurality of sections, wherein the power supply control box provided in each section receives electric power from the vehicle battery, and distributes and supplies electric power to a plurality of devices which are disposed in the same section and include at least the backup required device, and in each of the sections, the power supply control box is configured to be interposed between the backup battery and the backup required device in the same section so as to supply the backup electric power to the backup required device in the same section.

According to the backup battery system, it is possible to supply the backup electric power from the backup battery to the backup required device by using the power supply control box that receives electric power from the vehicle battery and distributes and supplies the electric power to a plurality of devices, and it is possible to realize commonization of a transmission route for the backup electric power and an electric power supply route during a normal operation in which the backup electric power is not supplied.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration diagram of an electric power supply system including a backup battery system according to a first embodiment of the present invention;

FIG. 2 is a schematic configuration diagram of an electric power supply system including a backup battery system according to a second embodiment; and

FIG. 3 is a schematic configuration diagram of a power supply control box illustrated in FIG. 2.

### DETAILED DESCRIPTION OF THE PREFERRED EMBODIMENTS

Hereinafter, the present invention will be described with reference to preferred embodiments. Furthermore, the present invention is not limited to the following embodiments, and appropriate modifications can be made in a range not departing from the gist of the invention. In addition, in the following embodiments, illustration or description of partial configurations is omitted, but it is needless to say that a technology, which is well known or commonly known, is appropriately applied to details of a technology that is omitted in a range in which a discrepancy from the following contents does not occur.

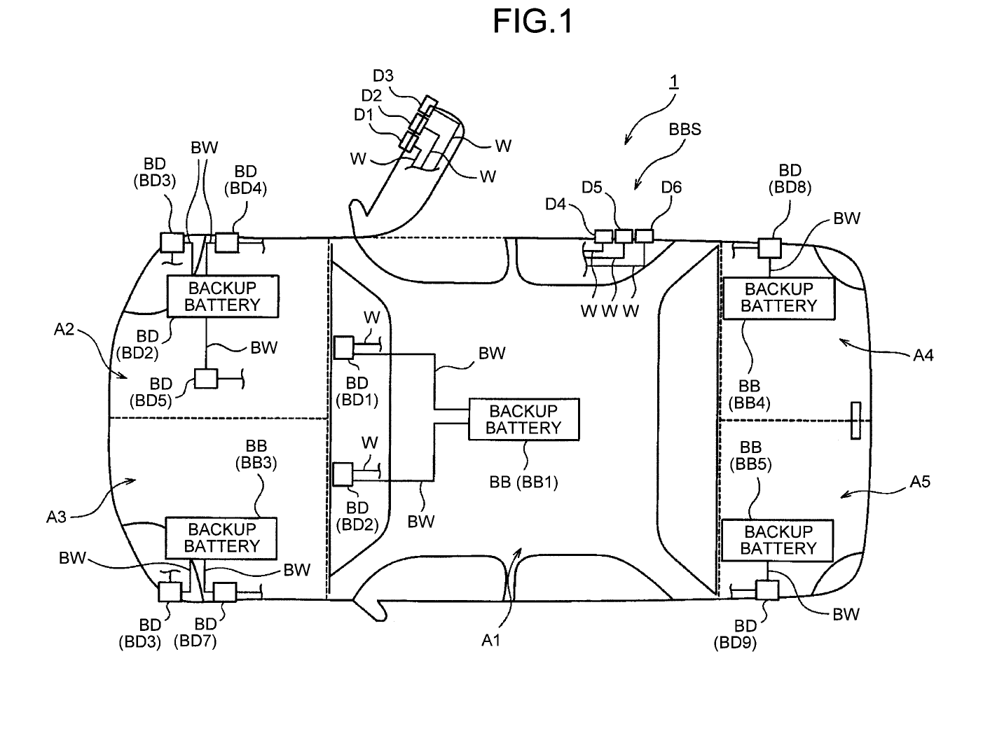

FIG. 1 is a schematic configuration diagram of an electric power supply system including a backup battery system according to a first embodiment of the present invention. As illustrated in FIG. 1, an electric power supply system 1 according to this embodiment includes a vehicle battery (not illustrated), a plurality of devices D1 to D6, and BD1 to BD9, respective electric wires W, and a backup battery system BBS.

The plurality of devices D1 to D6, and BD1 to BD9 operate by receiving electric power supply from a vehicle battery, and for example, a power window motor and the like correspond to the devices D1 to D6. An electric wire W is respectively connected to each of the devices D1 to D6, and BD1 to BD9, and electric power from the vehicle battery is supplied thereto through the electric wire W.

In addition, in the plurality of devices D1 to D6, and BD1 to BD9, backup required devices BD1 to BD9, to which backup electric power can be supplied, are present. Specifically, first and second backup required devices BD1 and BD2 are air-bag activation units, third and sixth backup required devices BD3 and BD6 are steering-by-wire units which execute a steer-by-wire technology capable of independently controlling steering by a steering wheel and change of a tire turning angle. In addition, fourth, and seventh to ninth backup required devices BD4, and BD7 to BD9 are electric motor brakes, and a fifth backup required device BD5 is a shift-by-wire unit that confirms whether or not a vehicle is in a shift state conforming to a shift position that is indicated by a shift lever, and performs failure detection in a case where the vehicle is not in the shift state. Furthermore, in the following description, in a case where the entirety or any one of the backup required devices BD1 to BD9 is not specified, a reference numeral BD is given (referred to as “backup required device BD”).

The backup battery system BBS includes a plurality of backup batteries BB1 to BB5 capable of outputting backup electric power, and a plurality of backup electric wires BW, and the plurality of backup required devices BD and the plurality of backup batteries BB1 to BB5 are connected by the backup electric wires BW. Furthermore, in the following description, in a case where the entirety or any one of the backup batteries BB1 to BB5 is not specified, a reference numeral BB is given (referred to as “backup battery BB”).

Specifically, the vehicle in the first embodiment is divided into a plurality of (five) rectangular sections A1 to A5, and the backup battery BB is disposed one by one in the sections A1 to A5. The five sections A1 to A5 includes a central section A1, a right front section A2, a left front section A3, a right rear section A4, and a left rear section A5. Among the sections, each of the sections A2 to A5 is set to include the vicinity of each tire of the vehicle.

Here, the backup battery BB is disposed one by one in the sections A1 to A5, and thus five backup batteries are mounted in the vehicle. On the other hand, as described above, as the backup required device BD, nine devices including first to ninth devices are mounted in the vehicle. That is, a plurality of the backup batteries BB which are respectively disposed in the plurality of sections A1 to A5 are connected to the backup required devices BD in a number greater than the number of sections.

Here, in the related art, one backup battery is necessary for one backup required device. However, in the first embodiment the plurality of backup batteries BB are connected to the backup required devices BD in a number greater than the number of sections. Accordingly, it is not necessary to mount the backup battery BB on a vehicle in a number corresponding to the number of the backup required devices BD, and the backup battery system BBS according to the first embodiment has a configuration capable of suppressing an increase in the number of the backup batteries which are mounted in the vehicle.

In addition, the backup battery BB in each of the sections A1 to A5 is connected to the backup required device BD in the same section among the sections A1 to A5 in a manner capable of supplying backup electric power thereto. That is, the first backup battery BB1, which is disposed in the central section A1, is connected to the first and second backup required devices BD1 and BD2 in the same section A1. In addition, the second backup battery BB2, which is disposed in the right front section A2, is connected to the third to fifth backup required devices BD3 to BD5 in the same section A2, and the third backup battery BB3, which is disposed in the left front section A3, is connected to the sixth and seventh backup required devices BD6 and BD7 in the same section A3. Similarly, the fourth backup battery BB4, which is disposed in the right rear section A4, is connected to the eighth backup required devices BD8 in the same section A4, and the fifth backup battery BB5, which is disposed in the left rear section A5, is connected to the ninth backup required device BD9 in the same section A5.

In addition, in the related art, in a case where one backup battery is provided in a vehicle, and the one backup battery and each of a plurality of backup required devices are connected by routing an electric wire from the one backup battery to each of the backup required devices over a range from a front side to a rear side of the vehicle, and thus an electric wire that is used in the vehicle is lengthened more than necessary. However, as described above, each of the backup batteries BB is connected to the backup required devices BD in the same section among the sections A1 to A5. Accordingly, electric wire connection is not made up to a distant backup required device BD in a different section among the sections A1 to A5. As a result, the backup battery system BBS according to the first embodiment has a configuration in which the backup electric wire BW, which connects the backup battery BB and the backup required device BD, can be further shortened.

In addition, the backup batteries BB2 to BB5 in the four sections A2 to A5 excluding the central section A1 are respectively disposed to be close to tires. Here, the backup required devices BD3 to BD9 mainly relate to vehicle traveling, and are generally provided in the vicinity of the tires due to the relation to the vehicle traveling. Accordingly, the backup batteries BB2 to BB5 are respectively disposed to be close to the tires, and thus the backup electric wire BW, which connects the backup battery BB and each of the backup required devices BD3 to BD9, can be further shortened. Furthermore, the close disposition represents disposition within a distance equal to or less than a width corresponding to two tires or three tires of the vehicle.

Next, description will be given of an operation of the electric power supply system 1 including the backup battery system BBS according to this embodiment. First, electric power from the vehicle battery is supplied to the plurality of devices D1 to D6, and BD1 to BD9. Here, in the vehicle, whether or not the vehicle battery is in an abnormal state is monitored by a battery monitoring unit from necessity such as notifying a driver and the like of the abnormality in the vehicle battery. Accordingly, in a situation in which electric power is not normally supplied from the vehicle battery, this situation is detected by the battery monitoring unit.

In addition, a signal from the battery monitoring unit is input to each of the backup required devices BD. According to this, a control unit and the like, which are provided in the backup required device BD, switch an electric power supply source from the vehicle battery to the backup battery BB. According to this, electric power is supplied to the backup required device BD.

Furthermore, in a case where electric power from the vehicle battery is not normally supplied, electric power is not supplied to the backup required device BD. Therefore, the control unit and the like cannot operate, and there is a possibility that the electric power supply source cannot be switched from the vehicle battery to the backup battery BB. Accordingly, the backup required device BD may be provided with, for example, a large-capacity capacitor that becomes an emergent power supply during emergency so as to secure temporary operation electric power for the control unit and the like by using the capacitor.

As described above, according to the backup battery system BBS according to this embodiment, the plurality of backup batteries BB, which are respectively disposed in the plurality of sections A1 to A5, are connected to the backup required devices BD in a number greater than the number of the sections. Accordingly, the number of the backup batteries BB becomes smaller than the number of the backup required devices BD, and it is possible to suppress an increase in the number of the backup batteries which are mounted in the vehicle. In addition, the backup battery BB in each of the sections A1 to A5 is connected to the backup required devices BD in the same section in a manner capable of supplying the backup electric power thereto.

Accordingly, the backup battery BB is connected to only the backup required devices BD in the same section, and electric wire connection is not made to a distant backup required device BD in a different section among the sections A1 to A5. As a result, it is possible to suppress an increase in the number of the backup batteries which are mounted in the vehicle, and it is possible to further shorten the backup electric wire BW that connects the backup battery BB and the backup required devices BD.

In addition, the plurality of sections A1 to A5 include the four sections A2 to A5 each of which is set to include the vicinity of each tire of the vehicle, and each of the backup batteries BB in the four sections A2 to A5 is disposed to be close to the respective tire. Here, the backup required device BD mainly relates to vehicle traveling, and is generally provided in the vicinity of the tire due to the relation to the vehicle traveling. Accordingly, when the backup battery BB is disposed to be close to the tire, it is possible to further shorten the backup electric wire BW that connects the backup battery BB and the backup required device BD.

Next, description will be given of a second embodiment of the invention. An electric power supply system 1 including a backup battery system BBS according to the second embodiment is substantially the same as the backup battery system in the first embodiment except for a partial configuration. Hereinafter, description will be given of a difference from the first embodiment.

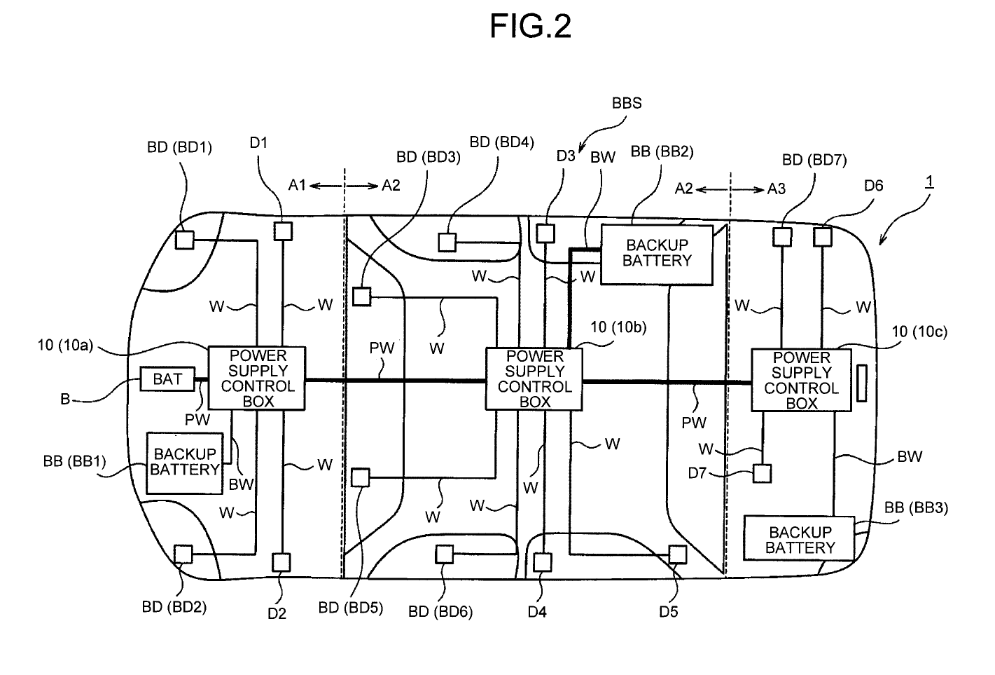

FIG. 2 is a schematic configuration diagram of the electric power supply system 1 including the backup battery system BBS according to the second embodiment. As illustrated in FIG. 2, the electric power supply system 1 according to the second embodiment includes a vehicle battery B, a plurality of devices D1 to D7, and BD1 to BD7, respective electric wires W, a backup battery system BBS, and a plurality of power supply control boxes 10. Backup required devices BD1 to BD7, to which backup electric power can be supplied, are included in the plurality of devices D1 to D7, and BD1 to BD7.

Particularly, the electric power supply system 1 according to the second embodiment can supply backup electric power to the backup required devices BD1 to BD7 by using a route through which electric power is supplied from the vehicle battery B to the plurality of devices D1 to D7, and BD1 to BD7. Hereinafter, description will be made in detail.

The backup battery system BBS includes a plurality of backup batteries BB1 to BB3 capable of outputting backup electric power, and a plurality of backup electric wires BW, and the plurality of backup required devices BD and the plurality of backup batteries BB1 to BB3 are connected by the backup electric wires BW, the power supply control boxes 10, and the electric wires W.

Specifically, a vehicle in the second embodiment is divided into a plurality of (three) rectangular sections A1 to A3, and the backup battery BB is disposed one by one in the sections A1 to A3. The three sections A1 to A3 include a front section A1, a central section A2, and a rear section A3.

Here, the backup battery BB is disposed one by one in the sections A1 to A3, and thus three batteries are mounted in the vehicle. On the other hand, as described above, six backup required devices BD are mounted in the vehicle. That is, the plurality of backup batteries BB which are disposed in the plurality of sections A1 to A3 are connected to the backup required devices BD in a number greater than the number of the sections.

The plurality of power supply control boxes 10 are disposed one by one in the sections A1 to A3. Each of the power supply control boxes 10 receives electric power from the vehicle battery B, and distributes and supplies electric power to the plurality of devices D1 to D7, and BD1 to BD6 which are disposed in the same section among the sections A1 to A3, through the electric wires W.

Specifically, a first power supply control box 10a distributes and supplies electric power to a plurality of devices D1, D2, BD1, and BD2 which are disposed in the front section A1 in which the first power supply control box 10a is disposed. A second power supply control box 10b distributes and supplies electric power to a plurality of devices D3 to D5, and BD3 to BD6 which are disposed in the central section A2 in which the second power supply control box 10b is disposed. A third power supply control box 10c distributes and supplies electric power to a plurality of devices D6, D7, and BD7 which are disposed in the rear section A3 in which the third power supply control box 10c is disposed.

Each of the backup electric wires BW in the second embodiment connects the backup battery BB and the power supply control box 10 in the same section among the sections A1 to A3. Accordingly, the backup battery BB in each of the sections A1 to A3 is connected to the backup required devices BD in the same section among the sections A1 to A3 through the power supply control box 10 and the electric wires W in a manner capable of supplying backup electric power thereto.

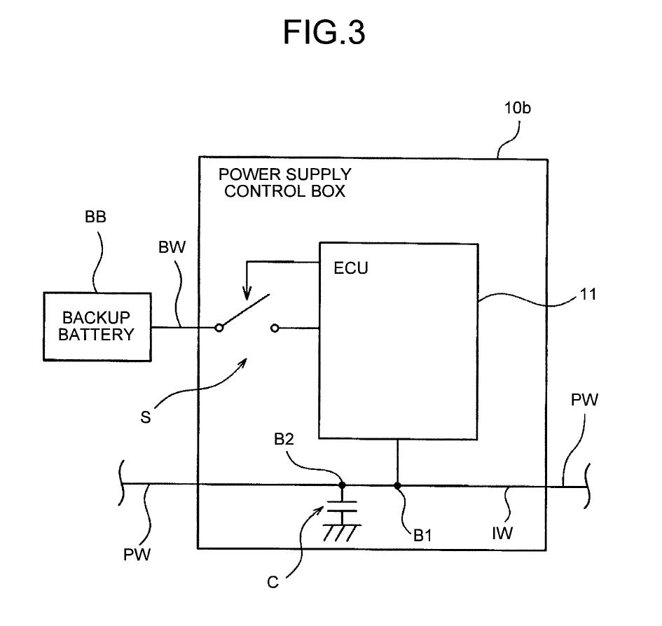

FIG. 3 is a schematic configuration diagram of the second power supply control box 10b illustrated in FIG. 2. Furthermore, a route, through which electric power is distributed and supplied to the plurality of devices D3 to D5, and BD3 to BD6, and components such as a switching element on the route are not illustrated in FIG. 3. In addition, operation electric power of the following ECU 11 is, for example, 5 V or the like, and a unit that lowers a voltage from the vehicle battery B or a voltage from the backup battery BB is also not illustrated in FIG. 3.

As illustrated in FIG. 3, the second power supply control box 10b includes the ECU 11 at the inside thereof. The ECU 11 performs switching control when supplying electric power to the plurality of devices D3 to D5, and BD3 to BD6. In addition, the second power supply control box 10b includes an internal electric wire IW, a large-capacity capacitor C that becomes an emergent power supply during emergency, and a switch S.

The internal electric wire IW is an electric wire that is connected to the power supply wire PW. The internal electric wire IW is branched on a branch point B1 and a branch wire is connected to the ECU 11. One end of the capacitor C is connected to a connection point B2 of the internal electric wire IW, and the other end is connected to a ground. Accordingly, during a normal operation, the capacitor C enters a state of being charged with electric power that is supplied through the power supply wire PW. The switch S is provided between the backup electric wire BW and the ECU 11, and is turned on or turned off so as to electrically connect or disconnect the ECU 11 and the backup battery BB. During a normal operation, the switch S is in an opened state, and the ECU 11 and the backup battery BB are disconnected.

Here, when electric power supply is impossible, electric power is not supplied through the power supply wire PW. Therefore, electric power is not supplied to the ECU 11. In this case, the capacitor C enter a discharging state, and electric power from the capacitor C is supplied to the ECU 11. According to this, the ECU 11 can temporarily operate.

On the other hand, a signal, which indicates that electric power supply from the vehicle battery B is impossible, is input to the ECU 11 from a battery monitoring unit. When the signal is input, the ECU 11 turns on the switch S so as to introduce electric power from the backup battery BB. According to this, electric power from the backup battery BB is supplied to the ECU 11. In addition, the backup battery BB is interconnected to the electric wire W, which is connected to the backup required device BD, in a manner capable of supplying electric power thereto, and electric power is supplied from the backup battery BB to the backup required device BD through switching control of the ECU 11.

Furthermore, in FIG. 3, description has been made with reference to the second power supply control box 10b as an example, but the description is also true of the configuration of the first and third power supply control boxes 10a and 10c, and the like.

As described above, according to the backup battery system BBS according to the second embodiment, as is the case with the first embodiment, it is possible to suppress an increase in the number of backup batteries which are mounted in the vehicle, and it is possible to further shorten the backup electric wire BW that connects the backup batteries BB and the backup required devices BD.

In addition, according to the second embodiment, it is possible to supply the backup electric power from the backup batteries BB to the backup required devices BD1 to BD6 by using the power supply control boxes 10 which receive electric power from the vehicle battery B and distribute and supply electric power to the plurality of devices D1 to D7, and BD1 to BD6, and it is possible to realize commonization of a transmission route for the backup electric power and an electric power supply route during a normal operation in which the backup electric power is not supplied.

Hereinbefore, the present invention has been described on the basis of the embodiments. However, the invention is not limited to the embodiments, and a modification can be made in a range not departing from the gist of the invention, and the embodiments may be combined or other technologies may be appropriately combined in a permissible range.

For example, in the embodiments, the backup required devices BD are not limited to the above-described examples, and may be other devices. In addition, the number of the backup batteries BB is not particularly limited to three or five as long as a plurality of the backup batteries BB are provided, and the number of the backup required devices BD is not particularly limited to six or nine.

In addition, in the example illustrated in FIG. 1, the backup batteries BB4 and BB5 in the sections A4 and A5 are respectively one-to-one connected to the backup required devices BD8 and BD9, but may be connected to a plurality of the backup required devices BD without limitation thereto.

The reason for this is as follows. Each of the backup batteries BB in all of the sections A1 to A5 is connected to the plurality of backup required devices BD, and thus among the sections A1 to A5, a section, in which the backup battery BB and the backup required device BD have one-to-one correspondence, does not exist. Accordingly, an increase in the number of the backup batteries is further suppressed. This is also true of the section A3 illustrated in FIG. 2.

In addition, whether or not electric power supply from the vehicle battery B is impossible is determined on the basis of a signal from the battery monitoring unit. However, there is no limitation thereto, and whether or not electric power supply is impossible may be determined by using a signal input from a current sensor or a voltage sensor which is provided to the vehicle battery B and the like.

According to the present invention, it is possible to provide a backup battery system that is capable of further shortening an electric wire that connects a backup battery and a backup required device while suppressing an increase in the number of backup batteries which are mounted in a vehicle.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A backup battery system comprising:
a backup battery configured to output backup electric power and to be connected to a backup required device among devices receiving electric power supply from a vehicle battery, the backup required device being a device to which the backup electric power is capable of being supplied, wherein
the backup battery is disposed in each of sections obtained by dividing a vehicle into a plurality of sections,
a plurality of the backup batteries, which are respectively disposed in the plurality of sections, are connected to a plurality of the backup required devices in a number greater than the number of the sections, and
the backup battery provided in each section is connected to the backup required device in the same section in a manner capable of supplying the backup electric power thereto.

2. The backup battery system according to claim 1, wherein
the plurality of sections include four sections each of which is set to include the vicinity of each tire of the vehicle, and
the backup batteries in the four sections are disposed to be close to the respective tires.

3. The backup battery system according to claim 1, further comprising:
a power supply control box provided one by one in the plurality of sections, wherein
the power supply control box provided in each section receives electric power from the vehicle battery, and distributes and supplies electric power to a plurality of devices which are disposed in the same section and include at least the backup required device, and
in each of the sections, the power supply control box is configured to be interposed between the backup battery and the backup required device in the same section so as to supply the backup electric power to the backup required device in the same section.

4. The backup battery system according to claim 2, further comprising:
a power supply control box provided one by one in the plurality of sections, wherein
the power supply control box provided in each section receives electric power from the vehicle battery, and distributes and supplies electric power to a plurality of devices which are disposed in the same section and include at least the backup required device, and
in each of the sections, the power supply control box is configured to be interposed between the backup battery and the backup required device in the same section so as to supply the backup electric power to the backup required device in the same section.
